(19) United States
(12) Patent Application Publication
(10) Pub. No.: US 2007/0226536 A1
(43) Pub. Date: Sep. 27, 2007

(54) Apparatus, system, and method for information validation in a heirarchical structure

(76) Inventors: Timothy James Crawford, Beaverton, OR (US); Michael Robert Groseclose JR., Tucson, AZ (US); David A. Larson, Tucson, AZ (US)

Correspondence Address: Kunzler & McKenzie, 8 EAST BROADWAY, SUITE 600, SALT LAKE CITY, UT, 84111, US

(21) Appl. No.: 11/348,075

(22) Filed: Feb. 6, 2006

(51) Int. Cl. G06F 11/00

(52) U.S. Cl. 714/13

(57) ABSTRACT

An apparatus, system, and method are disclosed for validating information in a hierarchical structure of redundant devices. A first plurality of redundant devices is examined to determine if status information residing within each of the redundant devices is consistent with each other. If the status information is inconsistent, the first plurality of redundant devices is identified as containing an error condition. If, however, the status information of the first plurality of redundant devices is consistent, all but one of the first plurality of redundant devices is excluded from further consideration. A second plurality of redundant devices, in communication with the all but one of the first plurality of redundant devices, is then examined to determine if status information residing within each of the second level of redundant devices is consistent with each other.

### BACKGROUND OF THE INVENTION

1. Field of the Invention

This invention relates to hierarchical data communication systems and more particularly relates to a branch-based validation method for redundant devices.

2. Description of the Related Art

Data communication systems, such as computer networks, often include complex arrangements of a multitude of digital data devices. For example, as illustrated by the schematic block diagram of FIG. 1, a traditional data communication system 10 may include digital data devices comprising a server computer (“server”) 12 connected to a user computer (“host”) 14 having digital data storage media 16 via a communication network 18 such as a local area network (“LAN”), a wide area network (“WAN”), a wireless network, or similar communication path. These exemplary digital data devices manipulate, process, transmit, and store digital information and generally include data storage registers 20 or similar memory devices for holding and displaying status information 22 pertaining to functionality and operability. A user of this traditional data communication system 10 or a system management application 24 may query the status information 22 of a digital data device to determine if it is currently powered on and operational or whether it is powered down, in standby mode, disabled, inaccessible, or otherwise not operational.

The traditional data communication system 10 may also include auxiliary devices such as a power controller card 26, a power supply 28, a fan 30 for cooling the power supply 28, and a battery 32 for providing auxiliary power. While the primary purpose of these auxiliary devices may not include manipulation, processing, transmitting, or storing digital information, these auxiliary devices may also include data storage registers 20 including status information 22. As with digital data devices, a user or system management application 24 may query the status information 22 of an auxiliary device to determine if it is currently powered on and operational or whether it is powered down, in standby mode, disabled, inaccessible, or otherwise not operational. Interconnections involving auxiliary devices may include power-transmission wires 34 and data communication channels 36 which may be either wired or wireless.

Complex data communication systems 100, as illustrated by the schematic block diagram of FIG. 2, are traditionally arranged in a heirarchical structure with each component in communication with one or more other components. Here, a server 112 having a data storage register 120 including status information 122 may be in communication with multiple power controller cards 126 that are, in turn, in communication with multiple power supplies 128. The power supplies 128 may be in communication with multiple batteries 132. By including multiple system components of like kind, a complex data communication system 100 may continue to function even if one or more system components fail or become inoperable. A user or a system management application 124 may query the status information 122 of individual components via the communication networks 118.

In order to prevent a single-point failure, as may occur in the traditional data communication system 10 of FIG. 1, complex data communication systems 100 generally include redundant component devices. For example, in order to prevent the disablement of a first power controller card 126a from causing a catastrophic system failure, a second power controller card 126b redundantly connects the power supplies 128a,-128d to the server 112. Likewise, the utilization of redundant power supplies 128a,-128d prevents the failure of either one from interrupting power flow from the batteries 132a,-132h to the power controller cards 126a, 126b.

The status information 122 stored in each data storage register 120 indicates the current viable of its associated device. For example, two mutually exclusive status conditions may be obtained, indicating either a currently nominal situation or an error within in the network. Another error condition known as a “can't happen” condition may also be obtained. However, unless an error condition is passed up the hierarchical structure, it may be difficult for the system management application to evaluate exactly which device is currently not operating properly.

As with all redundant devices, the status or information gathered from the devices needs to be verified and validated, particularly against its redundant partners. For example, if there are 3 peripherals in the system that are effectively redundant, their status must be compared against each other to confirm commonality and protect against conflicting status.

As the amount of layers of devices increase, and as the number of redundant devices per layer increase, there is an exponential increase in the number of different devices and paths that need to be verified.

A variety of diagnostic methods are known in the art involving various testing procedures to determine which component of the network is not functional. Commonly, however, the diagnostic methods require an operator to take at least part of the computer system offline in order to run the appropriate testing procedures.

Thus, a need exists for a system for analyzing generated mutually exclusive conflicts in a hierarchical network of redundant devices that ensures the network remains online, operable and usable. In addition, a need exists for a method of analysis and resolution of the mutually exclusive conflicts in a computer system, again under online conditions.

From the foregoing discussion, it should be apparent that a need exists for an apparatus, system, and method that perform a step-by-step approach to failure analysis in the online state by traversing the network of devices. Beneficially, such an apparatus, system, and method would perform this validation process in an organized, expandable, and portable fashion.

### SUMMARY OF THE INVENTION

The present invention has been developed in response to the present state of the art, and in particular, in response to the problems and needs in the art that have not yet been fully solved by currently available redundant peripheral systems. Accordingly, the present invention has been developed to provide an apparatus, system, and method for validating information in a hierarchical structure that overcome many or all of the above-discussed shortcomings in the art.

The apparatus to validate information in a hierarchical structure is provided with a plurality of modules configured to functionally execute the necessary steps of validating status information. These modules in the described embodiments include a validation module comprising a comparison module and an exclusion module.

The apparatus, in one embodiment, is configured to validate a first plurality of status information residing within a first plurality of redundant devices. The apparatus is further configured, in one embodiment, to identify an error condition if the first plurality of status information is inconsistent. In a further embodiment, the apparatus may be configured to disregard all but one of the first plurality of redundant devices if the first plurality of status information is consistent.

A system of the present invention is also presented to validate information residing within a hierarchical structure of redundant devices. The system may be embodied as a hierarchical structure of redundant devices and a server in communication with the hierarchical structure of redundant devices. In particular, the system, in one embodiment, includes a validation module for verifying a first plurality of status information of a first plurality of redundant devices.

The system may further include a comparison module for comparing the first plurality of status information, an identification module for identifying an error condition of the first plurality of devices if the first plurality of status information is inconsistent, and an exclusion module for disregarding all but one of the first plurality of devices if the first plurality of status information is consistent.

A method of the present invention is also presented for validating information in a hierarchical structure of redundant devices. The method in the disclosed embodiments substantially includes the steps necessary to carry out the functions presented above with respect to the operation of the described apparatus and system. In one embodiment, the method includes comparing a first plurality of status information residing within a first plurality of redundant devices, identifying an error condition of the first plurality of redundant devices if the first plurality of status information is inconsistent, and disregarding all but one of the first plurality of redundant devices if the first plurality of status information is consistent.

In a further embodiment, the method includes comparing a second plurality of status information residing within a second plurality of redundant devices in communication with the one of the first plurality of redundant devices, identifying a second error condition of the second plurality of redundant devices if the second plurality of status information is inconsistent, and disregarding all but one of the second plurality of redundant devices if the second plurality of status information is consistent.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating a traditional data communication system.

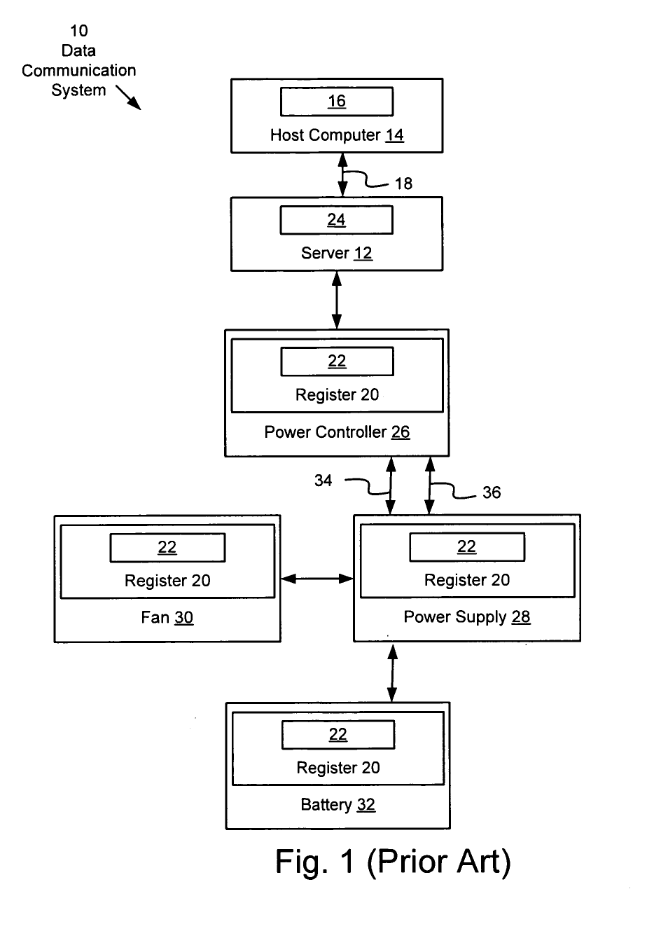

FIG. 2 is a schematic block diagram illustrating a complex data communication system.

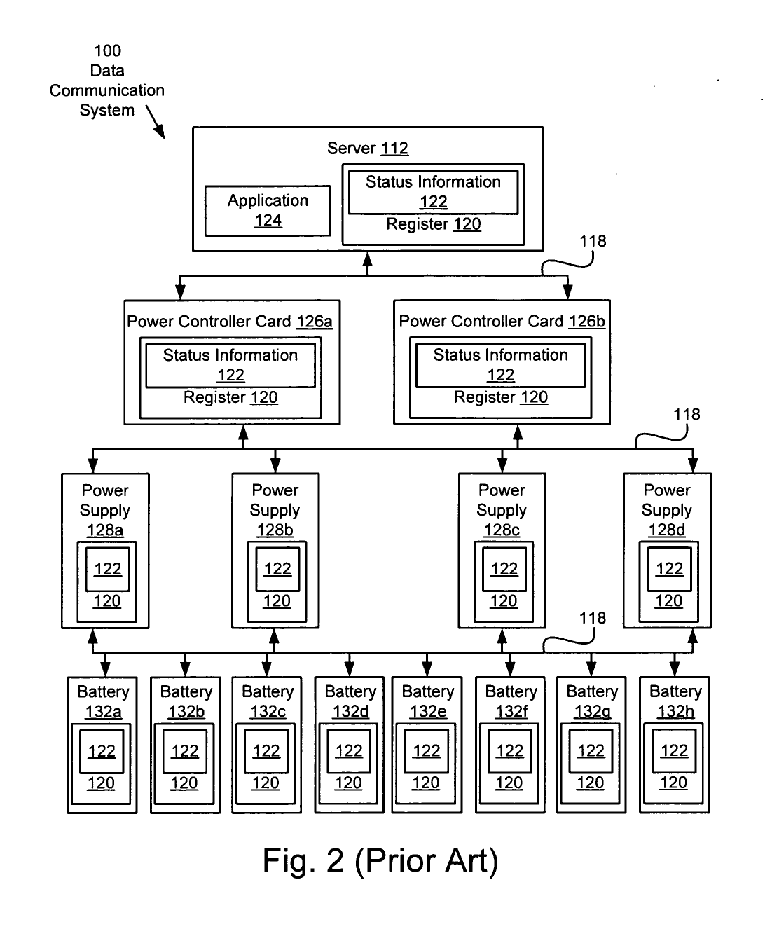

FIG. 3 is a schematic block diagram illustrating one embodiment of an information validation system in accordance with the present invention; and

FIG. 4 is a schematic flow chart diagram illustrating one embodiment of an information validation method in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form in, and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

The invention disclosed herein may be implemented as a method, apparatus, or signal bearing medium using standard programming or engineering techniques to produce software, firmware, hardware, or any combination thereof. A signal bearing medium may take any form capable of generating a signal, causing a signal to be generated, or causing execution of a program of machine-readable instructions on a digital processing apparatus. A signal bearing medium may be embodied by a transmission line, a compact disk, a digital-video disk, a magnetic tape, a Bernoulli drive, a magnetic disk, a punch card, a flash memory, an integrated circuit, an optical storage device, a floppy disk, an electrically-erasable programmable read-only memory (“EEPROM”), a volatile memory device, a non-volatile memory device, a field programmable gate array (“FPGA”), an application-specific integrated circuit (“ASIC”), a complex programmable logic device (“CPLD”), a programmable logic array (“PLA”), a microprocessor (“uP”), a programmable logic device (“PLD”), or other digital processing device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

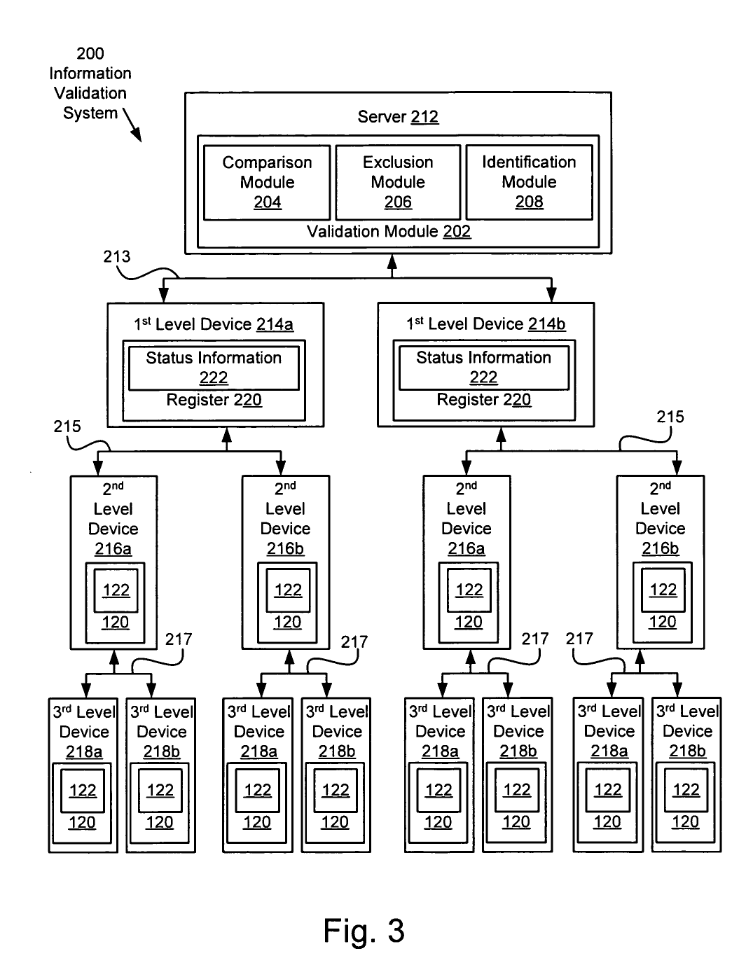

FIG. 3 depicts one embodiment of an information validation system 200 in accordance with the present invention, including a validation module 202 which, in turn, includes a comparison module 204, an exclusion module 206, and an identification module, as well as a server 212 and a pair of first level peripheral devices 214a, 214b. Each of the first level peripheral devices 214a, 214b are redundant similar devices that report to the server 212 over first level communication networks 213a, 213b. Second level peripheral devices 216a, 216b are also redundant peripheral devices that report to the first level peripheral devices 214a, 214b over second level communication networks 215a, 215b. The information reported by the second level peripheral devices 216a, 216b to the first level peripheral devices 214a, 214b is included in the information reported by the first level peripheral devices 214a, 214b to the server 212.

The third level of peripheral devices 218a, 218b are yet additional redundant devices that that report to the second level peripheral devices 216a, 216b over third level communication networks 217a, 217b. The information reported by the third level peripheral devices 218a, 218b to the second level peripheral devices 216a, 216b is included in the information reported by the second level peripheral devices 216a, 216b to the first level peripheral devices 214a, 214b which is, in turn, reported to the server 212.

Because the server 212 does not directly interface with the second level peripheral devices 216a, 216b and the third level peripheral devices 218a, 218b, the server 212 must access status information 222 stored in data storage registers 220 through any intermediary devices, such as the first level peripheral devices 214a, 214b. As each level of peripheral devices is added to the information validation system, an exponential increase in the number of required validation paths occurs.

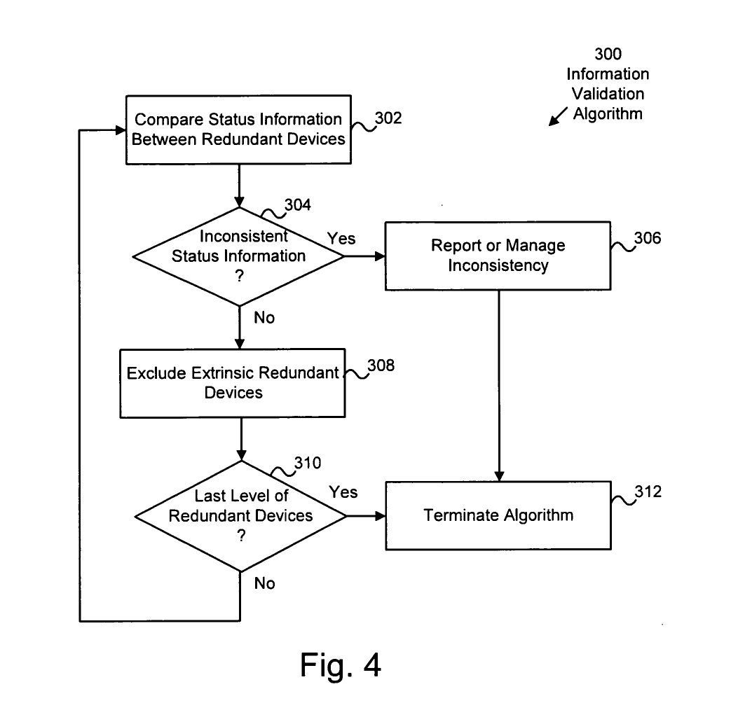

However, rather than applying a massive comparison of all elements against their redundant devices, the present embodiment of the invention breaks up the validation code into a series of simple checks using a folding algorithm. Additionally, the present invention utilizes the redundant nature of the peripheral devices to allow layers of peripheral devices to be inserted or removed without overhauling the design. The functional operation of the information validation system is best illustrated by the schematic flow chart diagram of the information validation algorithm 300 of FIG. 4.

The schematic flow chart diagram that follows is set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

First, the status information 222 of the first level peripheral devices 214a, 214b is compared 302 by the comparison module 204. If the status information 222 of the first level peripheral devices 214a, 214b is inconsistent 304, the inconsistency is reported or managed 306 by the comparison module 204. If the status information 222 is not inconsistent 304, then one of the first level peripheral devices 214b is excluded 308 from the validation process. In other words, if the status information of each first level peripheral device 214a, 214b is mutually compatible, extrinsic redundant first level peripheral device 214b, including any subordinate peripheral devices, may be removed from the set of peripheral devices to be analyzed by the exclusion module 206. If no more levels of peripheral devices exist 310, the algorithm terminates 312. However, if at least one additional level of peripheral devices does exist 310, then the algorithm returns to the step of comparing status information between redundant devices 302.

In one exemplary embodiment of the invention, the status information 222 of the second level peripheral devices 216a, 216b of the remaining first level peripheral device 214a is compared 302 by the comparison module 204. If the status information 222 of the second level peripheral devices 216a, 216b is consistent, one of the second level peripheral devices 216b, including any subordinate peripheral devices, is excluded 308 from the validation process by the exclusion module 206.

Traversing down the hierarchical structure of the information validation system, the status information 222 of the third level peripheral devices 218a, 218b, 218c of the remaining second level peripheral device 216a is compared 302 by the comparison module. If the status information 222 of the third level peripheral devices 218a, 218b, 218c is consistent, all but one of the third level peripheral devices, including any subordinate peripheral devices, is excluded 308 from the validation process by the exclusion module 206.

If the information validation algorithm terminates 312 without detecting inconsistent status information among redundant peripheral devices, then the status information of all of the peripheral devices in the information validation system 200 is deemed to be validated. If, however, an inconsistency exists among the status information 222 of like peripheral devices residing on the same level of the information validation system 200, the level of the non-validated peripheral devices is noted 306 by the identification module 208 before the information validation algorithm terminates 312.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus to validate information in a hierarchical redundant system, the apparatus comprising:
a server in communication with a first plurality of redundant devices;
wherein each of said first plurality of redundant devices comprises a first status information; and
validation module within the server, the validation module configured to validate the first status information of each of the first plurality of redundant devices.

2. The apparatus of claim 1, wherein the validation module is further configured to disregard all but one of the first plurality of redundant devices if the first status information of each of the first plurality of redundant devices is consistent with each other.

3. The apparatus of claim 1, wherein the validation module is further configured to identify the first plurality of redundant devices as containing inconsistent status information if the first status information of the first plurality of redundant devices is inconsistent.

4. The apparatus of claim 1, further comprising a comparison module within the validation module, the comparison module configured to compare the first status information of each of the first plurality of redundant devices.

5. The apparatus of claim 4, wherein the validation module further comprises an exclusion module configured to disregard all but one of the first plurality of redundant devices if the first status information of each of the first plurality of redundant devices is consistent with each other.

6. The apparatus of claim 4, wherein the validation module further comprises an identification module configured to identify the first plurality of redundant devices as containing inconsistent status information if the first status information of the first plurality of redundant devices is inconsistent.

7. The apparatus of claim 1, wherein each of the first plurality of devices further comprise a first status register configured to store the first status information.

8. A system to validate information in a redundant hierarchical system, the system comprising:
a first plurality of redundant devices, wherein each of the first plurality of redundant devices comprises a first status information; and
a server in communication with the first plurality of redundant devices, the server comprising a validation module configured to validate the first status information of each of the first plurality of redundant devices.

9. The system of claim 8, wherein the validation module is further configured to disregard all but one of the first plurality of redundant devices if the first status information of each of the first plurality of redundant devices is consistent with each other.

10. The system of claim 8, wherein the validation module is further configured to identify the first plurality of redundant devices as containing inconsistent status information if the first status information of the first plurality of redundant devices is inconsistent.

11. The system of claim 8, further comprising a comparison module within the validation module, the comparison module configured to compare the first status information of each of the first plurality of redundant devices.

12. The system of claim 11, wherein the validation module further comprises an exclusion module configured to disregard all but one of the first plurality of redundant devices if the first status information of each of the first plurality of redundant devices is consistent with each other.

13. The system of claim 11, wherein the validation module further comprises an identification module configured to identify the first plurality of redundant devices as containing inconsistent status information if the first status information of the first plurality of redundant devices is inconsistent.

14. The system of claim 11, wherein each of the first plurality of devices further comprise a first status register configured to store the first status information.

15. A signal bearing medium tangibly embodying a program of machine-readable instructions executable by a digital processing apparatus to perform an operation to validate information residing within redundant hierarchical devices, the operation comprising:
comparing a first plurality of status information residing within a first plurality of redundant devices;
identifying a first error condition of the first plurality of redundant devices if the first plurality of status information is inconsistent; and
validating the first plurality of redundant devices if the first plurality of status information is consistent.

16. The signal bearing medium of claim 15, wherein the instructions further comprise an operation to select one of the first plurality of devices if the first plurality of redundant devices has been validated.

17. The signal bearing medium of claim 16, wherein the instructions further comprise an operation to compare a second plurality of status information residing within a second plurality of redundant devices in communication with the one of the first plurality of devices.

18. The signal bearing medium of claim 17, wherein the instructions further comprise an operation to identify a second error condition of the second plurality of redundant devices if the second plurality of status information is inconsistent.

19. The signal bearing medium of claim 18, wherein the instructions further comprise an operation to validate the second plurality of redundant devices if the second plurality of status information is consistent.

20. The signal bearing medium of claim 19, wherein the instructions further comprise an operation to select one of the second plurality of devices if the second plurality of redundant devices has been validated.
